(19) United States
(12) Patent Application Publication
(10) Pub. No.: US 2017/0216644 A1
(43) Pub. Date: Aug. 3, 2017

(54) Fire Control System

(71) Applicant: Ariel Natividad, Buena Park, CA (US)

(72) Inventor: Ariel Natividad, Buena Park, CA (US)

(21) Appl. No.: 15/008,781

(22) Filed: Jan. 28, 2016

(51) Int. Cl. A62C 37/36; A62C 27/00

(52) U.S. Cl. CPC A62C 37/36; A62C 27/00

(57) ABSTRACT

A fire control system includes an unmanned aerial vehicle that may be flown proximate a burning structure. A vehicle is provided and a boom is movably coupled to the vehicle. The boom is positionable at a selected orientation with respect to the vehicle. The vehicle may be positioned adjacent to the burning structure thereby facilitating the boom to be maneuvered with respect to the burning structure. A fire extinguishing unit is movably coupled to the boom. The fire extinguishing unit receives a fluid thereby facilitating the fire extinguishing unit to direct the fluid onto the burning structure.

### BACKGROUND OF THE DISCLOSURE

### Field of the Disclosure

The disclosure relates to control devices and more particularly pertains to a new control device for remotely extinguishing a burning structure.

### SUMMARY OF THE DISCLOSURE

An embodiment of the disclosure meets the needs presented above by generally comprising an unmanned aerial vehicle that may be flown proximate a burning structure. A vehicle is provided and a boom is movably coupled to the vehicle. The boom is positionable at a selected orientation with respect to the vehicle. The vehicle may be positioned adjacent to the burning structure thereby facilitating the boom to be maneuvered with respect to the burning structure. A fire extinguishing unit is movably coupled to the boom. The fire extinguishing unit receives a fluid thereby facilitating the fire extinguishing unit to direct the fluid onto the burning structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a fire control system according to an embodiment of the disclosure.

FIG. 2 is a left side view of an embodiment of the disclosure.

FIG. 3 is a bottom view of an embodiment of the disclosure.

FIG. 4 is a cross sectional view taken along line 4-4 of FIG. 2 of an embodiment of the disclosure.

FIG. 5 is a left side perspective view of an embodiment of the disclosure.

FIG. 6 is a perspective in-use view of an embodiment of the disclosure.

FIG. 7 is a schematic view of an embodiment of the disclosure.

### DESCRIPTION OF THE PREFERRED EMBODIMENT

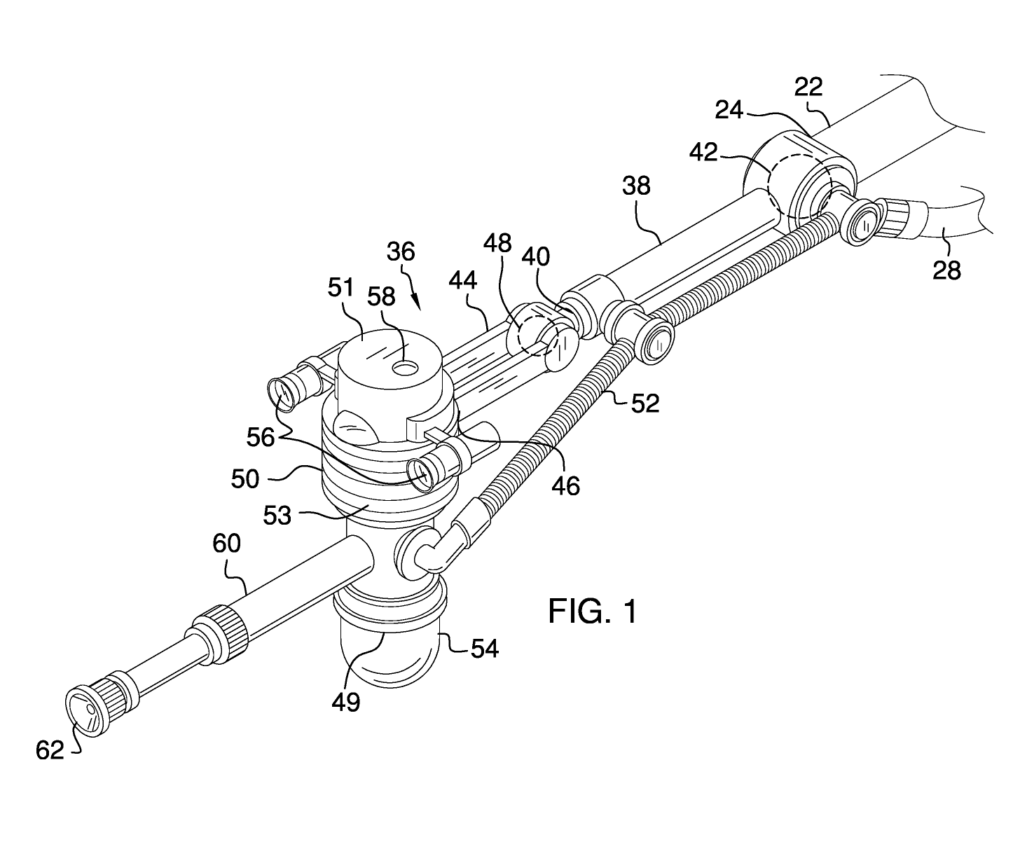

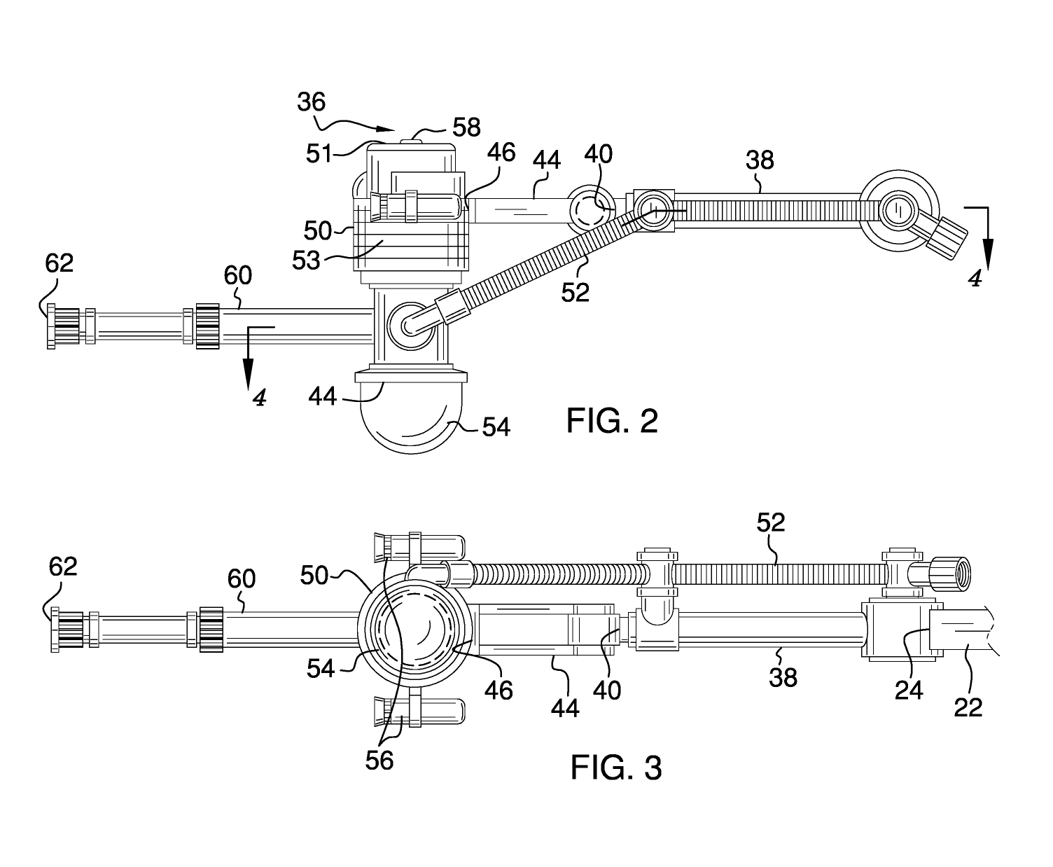

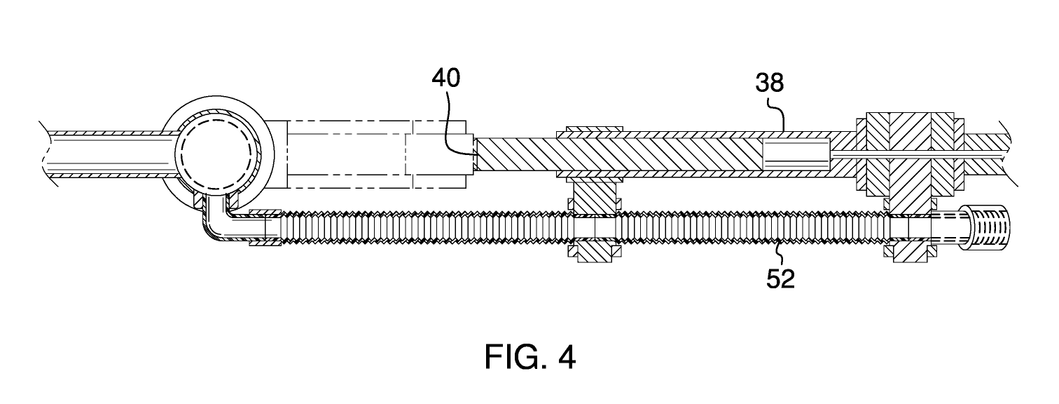

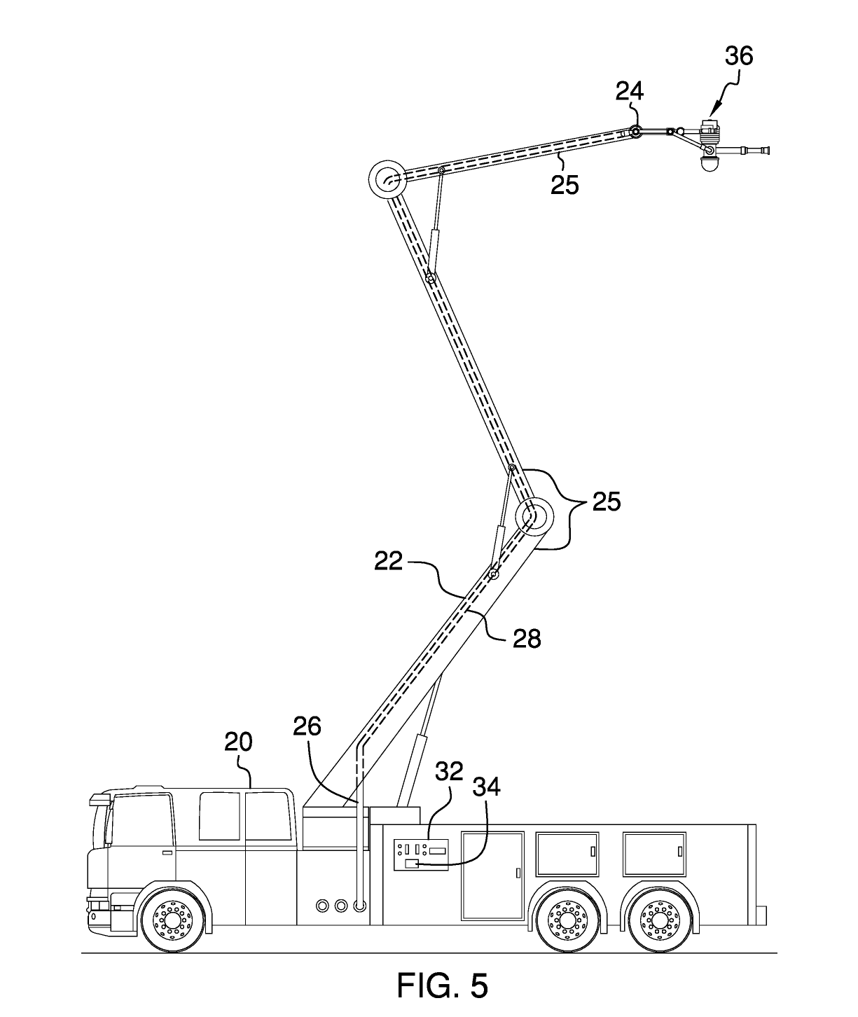

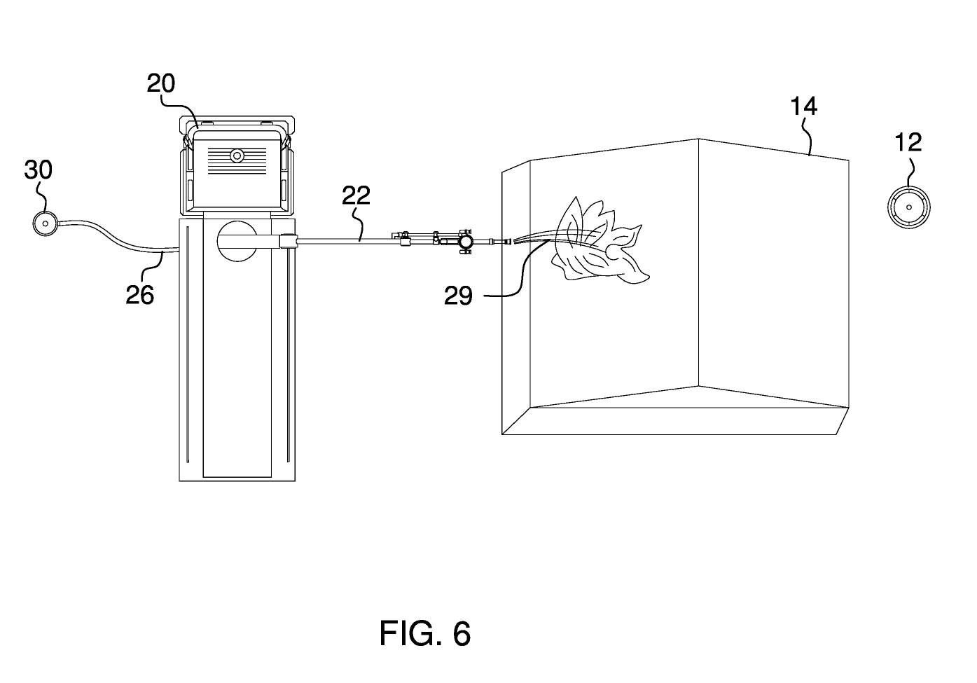

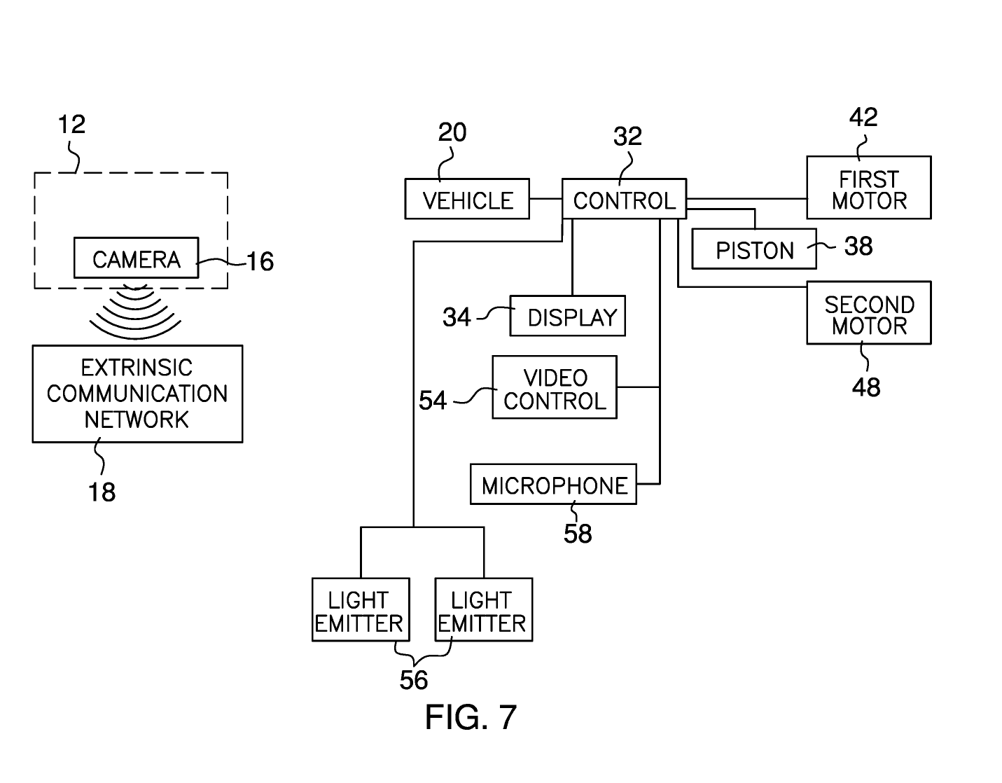

With reference now to the drawings, and in particular to FIGS. 1 through 7 thereof, a new control device embodying the principles and concepts of an embodiment of the disclosure and generally designated by the reference numeral 10 will be described.

As best illustrated in FIGS. 1 through 7, the fire control system 10 generally comprises an unmanned aerial vehicle 12 that may be flown proximate a burning structure 14. Thus, the unmanned aerial vehicle 12 may surveil the burning structure 14. The burning structure 14 may be a burning residential home or a burning commercial structure. The unmanned aerial vehicle 12 may comprise a remotely controlled drone or the like.

A camera 16 is coupled to the unmanned aerial vehicle 12. Thus, the unmanned aerial vehicle 12 may capture video footage of the burning structure 14. The unmanned aerial vehicle 12 is in electrical communication with an extrinsic communications network 18. The extrinsic communications network 18 may comprise a fire station communications network or the like. The unmanned aerial vehicle 12 may be operated by the fire station for the purposes of gathering surveillance of the burning structure 14.

A vehicle 20 is provided and a boom 22 is movably coupled to the vehicle 20. The boom 22 is positionable at a selected orientation with respect to the vehicle 20. The vehicle 20 may be positioned adjacent to the burning structure 14. Thus, the boom 22 may be maneuvered with respect to the burning structure 14. The boom 22 has a distal end 24 with respect to the vehicle 20 and the boom 22 may have a plurality of movable sections 25. Thus, the boom 22 is positionable in a plurality of geometric configurations.

The vehicle 20 may comprise a fire truck or the like and the boom 22 may comprise a hydraulically actuated boom or the like. A pumping unit 26 is coupled to the vehicle 20. The pumping unit 26 includes a hose 28 extending to the distal end 24 of the boom 22. The pumping unit 26 may be fluidly coupled to a fluid source 30 thereby facilitating the pumping unit 26 to urge a fluid 29 to the distal end 24. The fluid source 30 may comprise a fire hydrant and the fluid 29 may comprise water. The pumping unit 26 may comprise a fire truck pump of any conventional design.

A control 32 is coupled to the vehicle 20 and the control 32 may be manipulated. The control 32 is electrically coupled to the vehicle 20. The boom 22 is in communication with the control 32 such that the control 32 controls operational parameters of the boom 22. The control 32 includes a display 34. The display 34 may comprise an LCD or the like. The control 32 may comprise a hydraulic control panel or the like.

A fire extinguishing unit 36 is movably coupled to the boom 22. The fire extinguishing unit 36 receives the fluid thereby facilitating the fire extinguishing unit 36 to direct the fluid onto the burning structure 14. The fire extinguishing unit 36 is in electrical communication with the control 32. Thus, the control 32 controls operational parameters of the fire extinguishing unit 36.

The fire extinguishing unit 36 comprises a piston 38 that is coupled to the distal end 24 of the boom 22. The piston 38 has a distal end 40 with respect to the distal end 24 of the boom 22. The distal end 40 corresponding to the piston 38 is selectively extended and retracted with respect to the boom 22. The piston 38 is in communication with the control 32 such that the control 32 actuates the piston 38. The piston 38 may comprise a hydraulic piston or the like.

A first motor 42 is positioned within the piston 38 and the first motor 42 engages the distal end 24 of the boom 22. Thus, the first motor 42 urges the piston 38 to move upwardly and downwardly with respect to the boom 22. The first motor 42 is electrically coupled to the control 32 such that the control 32 controls operational parameters of the first motor 42. The first motor 42 may comprise an electrical motor or the like.

An arm 44 is hingedly coupled to the distal end 40 of the piston 38. Thus, the piston 38 selectively urges the arm 44 toward and away from the distal end 24 of the boom 22. The arm 44 has a distal end 46 with respect to the piston 38. A second motor 48 is positioned within the arm 44 and the second motor 48 engages the distal end 40 of the piston 38. Thus, the second motor 48 urges the arm 44 to move upwardly and downwardly with respect to the piston 38. The second motor 48 is electrically coupled to the control 32 such that the control 32 controls operational parameters of the second motor 48. The second motor 48 may comprise an electrical motor or the like.

A reservoir 50 is coupled to the distal end 46 of the arm 44. The reservoir 50 may have a bottom wall 49, a top wall 51 and an outer wall 53 extending between the top wall 51 and the bottom wall 49. The outer wall 53 may be curved such that the reservoir 50 has a cylindrical shape. The outer wall 53 may be coupled to the distal end 44 of the arm 44. A conduit 52 extends between the distal end 24 of the boom 22 and the reservoir 50. The conduit 52 is fluidly coupled to the hose 28 such that the fluid 29 is delivered to the reservoir 50. The conduit 52 is comprised of a resiliently stretchable material such that the conduit 52 expands and contracts when the piston 38 is extended and retracted.

A video camera 54 is coupled to the reservoir 50 and the video camera 54 may capture video footage of the burning structure 14. Thus, the fire extinguishing unit 36 may be strategically maneuvered with respect to the burning structure 14. The video camera 54 is electrically coupled to the display 34 and the display 34 displays the video footage. The video camera 54 may comprise a thermal imaging camera or the like. Thus, the camera 54 may locate individuals located within the burning structure 14. The video camera 54 may additionally comprise a three hundred sixty degree video camera or the like.

A pair of light emitters 56 is provided. Each of the light emitters 56 is coupled to the reservoir 50. Each of the light emitters 56 emits light toward the burning structure 14 and each of the light emitters 56 is electrically coupled to the control 32. Each of the light emitters 56 may comprise an LED or the like. A microphone 58 is coupled to the reservoir 50 and the microphone 58 may capture audio of the burning structure 14. The microphone 58 is electrically coupled to the control 32.

A nozzle 60 is fluidly coupled to the reservoir 50 and the nozzle 60 has a distal end 62 with respect to the reservoir 50. The nozzle 60 is oppositionally positioned with respect to the arm 44. Thus, the distal end 62 of the nozzle 60 may be directed toward the burning structure 14. The distal end 62 of the nozzle 60 is open and the nozzle 60 may deliver the fluid 29 onto the burning structure 14. Thus, the fluid 29 facilitates the burning structure 14 to be extinguished. The nozzle 60 may comprise a smooth bore firefighting nozzle or the like.

In use, the unmanned aerial vehicle 12 is flown under the control of the fire station when the fire station receives a fire call. The unmanned aerial vehicle 12 gathers surveillance of the burning structure 14 while the vehicle 20 is being dispatched to the burning structure 14. The unmanned aerial vehicle 12 communicates logistical information about the burning structure 14 to the vehicle 20. Thus, the vehicle 20 may be positioned at an optimal position to extinguish the burning structure 14.

The pumping unit 26 is fluidly coupled to the fluid source 30 and the boom 22 is maneuvered to direct the fire extinguishing unit 36 toward the burning structure 14. The nozzle 60 directs the fluid 29 onto the burning structure 14. The first motor 42 and the second motor 48 are actuated to make fine adjustments to the direction of the nozzle 60. The display 34 is observed while the fluid 29 is directed onto the burning structure 14. The unmanned aerial vehicle 12 and the boom 22 inhibit a fireman from being near the burning structure 14. Thus, loss of human life and injury is reduced while the burning structure 14 is extinguished.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire control system comprising:
an unmanned aerial vehicle being configured to be flown proximate a burning structure thereby facilitating said unmanned aerial vehicle to surveil the burning structure;
a vehicle having a boom being movably coupled to said vehicle, said boom being positionable at a selected orientation with respect to said vehicle, said vehicle being configured to be positioned adjacent to the burning structure thereby facilitating said boom to be maneuvered with respect to the burning structure;
a pumping unit being coupled to said vehicle, said pumping unit being configured to be fluidly coupled to a fluid source thereby facilitating said pumping unit to urge a fluid to said boom;
a control being coupled to said vehicle wherein said control is configured to be manipulated, said boom being in electrical communication with said control such that said control controls operational parameters of said boom; and
a fire extinguishing unit being movably coupled to said boom wherein said fire extinguishing unit is configured to receive the fluid thereby facilitating said fire extinguishing unit to direct the fluid onto the burning structure, said fire extinguishing unit being in electrical communication with said control such that said control controls operations parameters of said fire extinguishing unit.

2. The system according to claim 1, wherein:
said boom has a distal end with respect to said vehicle; and
said fire extinguishing unit comprises a piston being coupled to said distal end of said boom, said piston having a distal end with respect to said distal end of said boom, said distal end corresponding to said piston being selectively extended away from said boom, said piston being in electrical communication with said control such that said control actuates said piston.

3. The system according to claim 2, further comprising a first motor being positioned within said piston, said first motor engaging said distal end of said boom such that said motor urges said piston to move upwardly and downwardly with respect to said boom, said first motor being electrically coupled to said control such that said control controls operational parameters of said first motor.

4. The system according to claim 2, further comprising an arm being hingedly coupled to said distal end of said piston such that said piston selectively urges said arm toward and away from said distal end of said boom, said arm having a distal end with respect to said piston.

5. The system according to claim 4, further comprising a second motor being positioned within said first arm, said second motor engaging said distal end of said piston such that said second motor urges said arm to move upwardly and downwardly with respect to said piston, said second motor being electrically coupled to said control such that said control controls operational parameters of said second motor.

6. The system according to claim 4, further comprising:
a reservoir being coupled to said distal end of said arm;
a hose; and
a conduit extending between said distal end of said boom and said reservoir, said conduit being fluidly coupled to said hose such that the fluid is delivered to said reservoir, said conduit being comprised of a resiliently stretchable material such that said conduit expands and contracts when said piston is extended and retracted.

7. The system according to claim 1, further comprising:
a reservoir;
a display; and
a video camera being coupled to said reservoir wherein said video camera is configured to capture video footage of the burning structure thereby facilitating said fire extinguishing unit to be strategically maneuvered with respect to the burning structure, said video camera being electrically coupled to said display wherein said display is configured to display the video footage.

8. The system according to claim 1, further comprising:
a reservoir;
a pair of light emitters, each of said light emitters being coupled to said reservoir wherein each of said light emitters is configured to emit light toward the burning structure, each of said light emitters being electrically coupled to said control; and
a microphone being coupled to said reservoir wherein said microphone is configured to capture audio of the burning structure, said microphone being electrically coupled to said control.

9. The system according to claim 6, further comprising a nozzle being fluidly coupled to said reservoir, said nozzle having a distal end with respect to said reservoir, said nozzle being oppositionally positioned with respect to said arm wherein said distal end of said nozzle is configured to be directed toward the burning structure, said distal end of said nozzle being open wherein said nozzle is configured to deliver the fluid onto the burning structure thereby facilitating the burning structure to be extinguished.

10. A fire control system comprising:
an unmanned aerial vehicle being configured to be flown proximate a burning structure thereby facilitating said unmanned aerial vehicle to surveil the burning structure, said unmanned aerial vehicle having a camera being coupled thereto wherein said unmanned aerial vehicle is configured to capture video footage of the burning structure, said unmanned aerial vehicle being configured to be in electrical communication with an extrinsic communications network;
a vehicle having a boom being movably coupled to said vehicle, said boom being positionable at a selected orientation with respect to said vehicle, said vehicle being configured to be positioned adjacent to the burning structure thereby facilitating said boom to be maneuvered with respect to the burning structure, said boom having a distal end with respect to said vehicle;
a pumping unit being coupled to said vehicle, said pumping unit including a hose extending to said distal end of said boom, said pumping unit being configured to be fluidly coupled to a fluid source thereby facilitating said pumping unit to urge a fluid to said distal end;
a control being coupled to said vehicle wherein said control is configured to be manipulated, said control being electrically coupled to said vehicle, said boom being in electrical communication with said control such that said control controls operational parameters of said boom, said control including a display;
a fire extinguishing unit being movably coupled to said boom wherein said fire extinguishing unit is configured to receive the fluid thereby facilitating said fire extinguishing unit to direct the fluid onto the burning structure, said fire extinguishing unit being in electrical communication with said control such that said control controls operations parameters of said fire extinguishing unit, said fire extinguishing unit comprising:
a piston being coupled to said distal end of said boom, said piston having a distal end with respect to said distal end of said boom, said distal end corresponding to said piston being selectively extended away from said boom, said piston being in electrical communication with said control such that said control actuates said piston,
a first motor being positioned within said piston, said first motor engaging said distal end of said boom such that said motor urges said piston to move upwardly and downwardly with respect to said boom, said first motor being electrically coupled to said control such that said control controls operational parameters of said first motor,
an arm being hingedly coupled to said distal end of said piston such that said piston selectively urges said arm toward and away from said distal end of said boom, said arm having a distal end with respect to said piston,
a second motor being positioned within said first arm, said second motor engaging said distal end of said piston such that said second motor urges said arm to move upwardly and downwardly with respect to said piston, said second motor being electrically coupled to said control such that said control controls operational parameters of said second motor,
a reservoir being coupled to said distal end of said arm,
a conduit extending between said distal end of said boom and said reservoir, said conduit being fluidly coupled to said hose such that the fluid is delivered to said reservoir, said conduit being comprised of a resiliently stretchable material such that said conduit expands and contracts when said piston is extended and retracted,
a video camera being coupled to said reservoir wherein said video camera is configured to capture video footage of the burning structure thereby facilitating said fire extinguishing unit to be strategically maneuvered with respect to the burning structure, said video camera being electrically coupled to said display wherein said display is configured to display the video footage,
a pair of light emitters, each of said light emitters being coupled to said reservoir wherein each of said light emitters is configured to emit light toward the burning structure, each of said light emitters being electrically coupled to said control,
a microphone being coupled to said reservoir wherein said microphone is configured to capture audio of the burning structure, said microphone being electrically coupled to said control, and
a nozzle being fluidly coupled to said reservoir, said nozzle having a distal end with respect to said reservoir, said nozzle being oppositionally positioned with respect to said arm wherein said distal end of said nozzle is configured to be directed toward the burning structure, said distal end of said nozzle being open wherein said nozzle is configured to deliver the fluid onto the burning structure thereby facilitating the burning structure to be extinguished.
